(19) United States
(12) Patent Application Publication
(10) Pub. No.: US 2025/0196641 A1
(43) Pub. Date: Jun. 19, 2025

(54) METHOD AND APPARATUS FOR PROVIDING CONTENT IN A VEHICLE

(71) Applicants: HYUNDAI MOTOR COMPANY, Seoul (KR); KIA CORPORATION, Seoul (KR)

(72) Inventors: La Woo Kim, Seoul (KR); Seung Yeon Lee, Seoul (KR)

(73) Assignees: HYUNDAI MOTOR COMPANY, Seoul (KR); KIA CORPORATION, Seoul (KR)

(21) Appl. No.: 18/670,131

(22) Filed: May 21, 2024

(30) Foreign Application Priority Data
Dec. 14, 2023 (KR) 10-2023-0181906

(51) Int. Cl. B60K 35/28; G06Q 30/0207; G10L 15/22

(52) U.S. Cl. CPC B60K 35/28; G06Q 30/0207; G10L 15/22; B60K 2360/164

(57) ABSTRACT

An in-vehicle content provision method and apparatus are provided. The in-vehicle content provision method includes generating first information from content of conversations of passengers of a vehicle. The method also includes generating second information from a video displayed in the vehicle. The method additionally includes generating interest information on the basis of the first information and the second information. The method further includes receiving point-of-interest (POI) information from a server. The method also includes generating, on the basis of the interest information and the POI information, content to be provided to the passengers of the vehicle and providing the generated content to the passengers of the vehicle.

### CROSS-REFERENCE TO RELATED APPLICATION

This application claims priority to Korean Patent Application No. 10-2023-0181906, filed on Dec. 14, 2023, in the Korean Intellectual Property Office, the disclosure of which is hereby incorporated herein by reference.

### BACKGROUND OF THE DISCLOSURE

### 1. Field of the Disclosure

The present disclosure relates to smart mobility. More specifically, the present disclosure relates to a method and apparatus for providing content in a vehicle running on a smart mobility platform.

### 2. Description of the Related Art

Recently, as the standard of living has improved and vehicle culture has become routine, the time that passengers spend inside vehicles is increasing due to long-distance driving such as travel, traffic jams, and the like. Accordingly, various convenience facilities and convenience services are provided in the interior of vehicles for convenience of passengers who stay inside the vehicles for a long period of time.

A representative example of such convenience services is a telematics service. Telematics is a combination of telecommunications and information science and is a next-generation information provision service for automobiles through combination of information technology (IT) and automobile industries in which wireless communication, automobiles, terminals, and content are organically related.

Conventional telematics services can provide various services such as traffic and driving information, emergency response information, remote vehicle diagnosis services, the Internet, e-mail service, lifestyle information, and entertainment through in-vehicle terminals using wireless communication technology and satellite positioning system (global positioning system (GPS)) technology.

More recently, the concept of mobility that provides entertainment and convenient movement is being introduced in navigation provided in vehicles. When autonomous driving is added, vehicles can serve as a cultural space beyond the simple concept of transportation. Recently, in addition to the navigation function, various functions such as radio playback linked to digital audio broadcasting (DAB) and digital multimedia broadcasting (DMB), media playback linked to Bluetooth (e.g., media content such as Spotify, Melon, etc.), built-in cameras, weather information provision, sports information provision, phone projection function, voice memo, phone, Hi-Pass, sharing my car location, calendar, CarPlay, valet mode, and vehicle diagnosis are provided. Drivers can navigate to destinations using such a navigation function.

However, conventional navigation or telematics services typically cannot provide advertising content. Further, even if advertising content is provided, conventional navigation or telematics services only provide a certain advertisement at a set time and do not provide customized advertising content based on passengers' interests or video information provided from vehicles.

### SUMMARY

Therefore, in this technical field, there is a demand for technology capable of providing customized advertising content based on the content of conversations of passengers or video information displayed in a vehicle.

The present disclosure has been made in view of the above problems. An object of the present disclosure is to provide customized advertising content based on the content of conversations of passengers or video information played in a vehicle.

Another object of the present disclosure is to provide useful information, such as information on restaurants or other stores and discount information related thereto, to passengers of a vehicle on the basis of information generated by matching point-of-interest (POI) information with words extracted from the content of conversations of passengers and video information played in the vehicle.

The objects to be achieved in the present disclosure are not limited to the objects mentioned above. Other objects not mentioned should be more clearly understood by those having ordinary skill in the art from the description below.

In accordance with an aspect of the present disclosure, a method of providing content is provided. The method includes generating first information from content of conversations of passengers of a vehicle. The method also includes generating second information from a video displayed in the vehicle. The method additionally includes generating interest information on the basis of the first information and the second information. The method further includes receiving point-of-interest (POI) information from a server. The method further still includes generating content to be provided on the basis of the interest information and the POI information. The method also includes providing the generated content to the passengers of the vehicle.

In an aspect, the first information may include information on words whose frequency of use exceeds a preset first threshold among words included in the conversations, obtained by analyzing the conversations of the passengers of the vehicle through voice recognition.

In an aspect, the first information may include information in which words included in the conversations are sorted in order of frequency of use during a preset first critical time.

In an aspect, the second information may include information on words whose frequency of use in captions, images, and voice exceeds a preset second threshold among words in a list of words, where captions, images, and voice included in a video received by the vehicle from a server or an external device are analyzed to generate the list of words.

In an aspect, the second information may include information in which the words in the list of words are sorted in order of frequency of use during a preset second critical time.

In an aspect, the POI information may include information on a store stored in a database in the server.

In an aspect, the information on the store may include at least one of identification information of the store, information on items currently on discount, discount rates of the items currently on discount, or a combination thereof.

In an aspect, the method may further include receiving location information of the vehicle. Providing the generated content to the passengers of the vehicle may include providing the generated content on the basis of the location information of the vehicle.

In an aspect, the location information of the vehicle may be received from a global positioning system (GPS) server.

In an aspect, the interest information may include a common word or related words matching each other among words in the first information and the second information.

In accordance with another aspect of the present disclosure, an apparatus for providing content is provided. The apparatus includes a communication unit configured to receive point-of-interest (POI) information from a server. The apparatus also includes a processor configured to generate first information from content of conversations of passengers of a vehicle. The processor is also configured to generate second information from a video displayed in the vehicle. The processor is further configured to generate interest information on the basis of the first information and the second information. The processor is additionally configured to generate, on the basis of the interest information and the POI information, content to be provided to the passengers of the vehicle. The processor is further configured to provide the generated content to the passengers of the vehicle.

In an aspect, the first information may include information on words whose frequency of use exceeds a preset first threshold among words included in the conversations, obtained by analyzing the conversations of the passengers of the vehicle through voice recognition.

In an aspect, the first information may include information in which words included in the conversations are sorted in order of frequency of use during a preset first critical time.

In an aspect, the second information may include information on words whose frequency of use in captions, images, and voice exceeds a preset second threshold among words in a list of words, where captions, images, and voice included in a video received by the vehicle from a server or an external device are analyzed to generate the list of words.

In an aspect, the second information may include information in which the words in the list of words are sorted in order of frequency of use during a preset second critical time.

In an aspect, the POI information may include information on a store stored in a database in the server.

In an aspect, the information on the store may include at least one of identification information of the store, information on items currently on discount, discount rates of the items currently on discount, or a combination thereof.

In an aspect, the communication unit may be further configured to receive location information of the vehicle. The processor may be further configured to provide the generated content to the passengers of the vehicle on the basis of the location information of the vehicle.

In an aspect, the location information of the vehicle may be received from a global positioning system (GPS) server.

In an aspect, the interest information may include a common word or related words matching each other among words in the first information and the second information.

### BRIEF DESCRIPTION OF THE DRAWINGS

The above and other objects, features, and advantages of the present disclosure should be more clearly understood from the following detailed description taken in conjunction with the accompanying drawings, in which:

FIG. 1 is a block diagram schematically showing an advertising content provision system, according to an embodiment of the present disclosure;

FIG. 2 is a block diagram schematically showing a content provision apparatus, according to an embodiment of the present disclosure;

FIG. 3 is a flowchart showing a content provision method, according to an embodiment of the present disclosure; and

FIG. 4 is a block diagram showing an example of a computer system, according to an embodiment of the present disclosure.

### DETAILED DESCRIPTION

Hereinafter, embodiments of the present disclosure are described in detail with reference to the accompanying drawings. In the following description and the accompanying drawings, identical or similar components are assigned the same reference numeral, and redundant descriptions thereof have been omitted. The suffixes “module,” “unit,” or the like, of elements herein are used for convenience of description. Thus, the suffixes can be used interchangeably and do not have any distinguishable meanings or functions. In the following description of embodiments of the present disclosure, a detailed description of known functions and configurations incorporated herein has been omitted where it has been determined that the detailed description may have obscured the subject matter of the present disclosure. In addition, the accompanying drawings are provided only for ease of understanding of the embodiments disclosed in the present disclosure. The accompanying drawings do not limit the technical spirit disclosed herein, and include all changes, equivalents, and substitutes included in the spirit and scope of the present disclosure.

The terms “first” and/or “second” are used to describe various components, but such components are not limited by these terms. The terms are used to discriminate one component from another component.

When a component is described as being “coupled” or “connected” to another component, it should be understood that a third component may be present between the two components or the component may be directly coupled or connected to the other component. When a component is described as being “directly coupled” or “directly connected” to another component, it should be understood that no element is present between the two components.

An element described in the singular form is intended to include a plurality of elements unless the context clearly indicates otherwise.

In the present specification, the terms “comprise,” “comprising,” “include,” “including,” or the like, specify the presence of a stated feature, figure, step, operation, component, part, or combination thereof. However, such terms do not preclude the presence or addition of one or more other features, figures, steps, operations, components, or combinations thereof.

When a component, device, element, or the like of the present disclosure is described as having a purpose or performing an operation, function, or the like, the component, device, or element should be considered herein as being “configured to” meet that purpose or perform that operation or function.

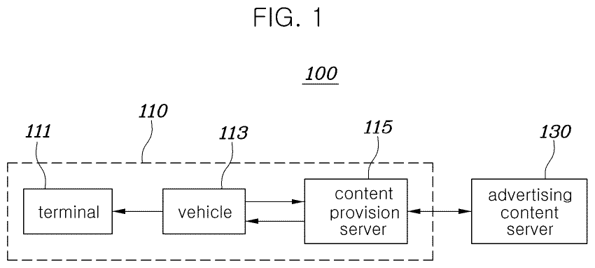

FIG. 1 is a block diagram schematically showing an advertising content provision system, according to an embodiment of the present disclosure.

Referring to FIG. 1, the advertising content provision system 100 according to an embodiment includes a content provision system 110 and an advertising content server 130.

The content provision system 110 provides audio-visual content to vehicle passengers. The content provision system 110 includes a terminal 111, a vehicle 113, and a content provision server 115.

The terminal 111 receives the content of conversations of passengers of the vehicle 113, provides images that the passengers can view within the vehicle 113, and provides content generated based on the content of the conversations and the images to the passengers of the vehicle 113.

Terminals include a smartphone, a portable terminal, a mobile terminal, a foldable terminal, a personal digital assistant (PDA), a portable multimedia player (PMP) terminal, a telematics terminal, a navigation terminal, a personal computer, a laptop computer, a slate PC, a tablet computer, an ultrabook, wearable devices (e.g., a smartwatch, smartglasses, or a head mounted display (HMD), etc.), a WiBro terminal, an (Internet protocol television (IPTV) terminal, a smart TV, a digital broadcasting terminal, an audio/video/navigation (AVN) terminal, an audio/video (A/V) system, a flexible terminal, a digital signage device, or the like. In embodiments, information transmission and reception between the content provision server 115 or the vehicle 113 and the terminal 111 may be performed through an application installed in the terminal 111 or an Internet browser.

A video displayed on the terminal 111 may be received from an Over-The-Top (OTT) server or from a device connected to the terminal 111. For example, the device connected to the terminal 111 may be a Universal Serial Bus (USB) device.

The terminal 111 may receive information on the current location from a GPS server.

The terminal 111 may also receive information on the current date and time from a time server and information on the current weather from a weather server.

The vehicle 113 receives the content of conversations of passengers and moves the passengers to a desired destination.

The vehicle 113 may receive information on the current location from a GPS server.

The content provision server 115 transmits POI information to the terminal 111 or the vehicle 113.

The content provision server 115 may include a database, and may store information on at least one store in the database.

Information on a store may include at least one of identification information of the store, information on items currently on discount, discount rates of the items on discount, or a combination thereof.

The information on the store may be received from the advertising content server 130.

The content provision server 115 may be, for example, a server provided by a vehicle manufacturer. The advertising content server 130 may be, for example, a server provided by an advertising agency.

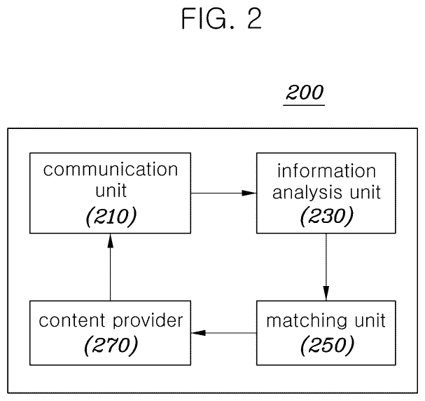

FIG. 2 is a block diagram schematically showing a content provision apparatus, according to an embodiment of the present disclosure.

The content provision apparatus 200 according to the present embodiment may be a vehicle or a terminal. For example, the content provision apparatus 200 may be a navigation device installed in a vehicle.

Referring to FIG. 2, the content provision apparatus 200 according to an embodiment includes a communication unit 210, an information analysis unit 230, a matching unit 250, and a content provider 270.

The communication unit 210 receives the content of conversations of vehicle passengers, video information displayed in the vehicle, external environment information of the vehicle, POI information, and the like from an external server or an external device. The communication unit 210 also transmits the same to the information analysis unit 230. For example, the communication unit 210 may collect information on the content of conversations of passengers from a microphone installed in the vehicle. The microphone is provided on the driver's seat of the vehicle or each of the seats provided in the vehicle to record audio information of passengers and transmit the same to the information analysis unit 230.

Information received through the communication unit 210 includes information on external factors such as vehicle location information, weather, temperature, humidity, illumination, date and time, driving roads, and traffic conditions, and information on internal factors such as a vehicle speed, states before/after driving, stopping, parking, restarting, and/or a vehicle mode.

The vehicle location information may be received from a global positioning system (GPS) server.

The information analysis unit 230 analyzes the content of conversations of received from the passengers communication unit 210 through voice recognition. The information analysis unit 230 generates information on words whose frequency of use exceeds a preset first threshold value among words included in the conversations.

The words whose frequency of use exceeds the preset first threshold value among the words included in the conversations may be included in first information generated by the information analysis unit 230.

The first information may include information in which words included in the conversations are sorted in order of frequency of use during a preset first critical time.

For example, if “chicken” was mentioned 5 times and “dumplings” was mentioned 4 times in the content of conversations of passengers during the last hour, the information analysis unit 230 may include information on “chicken”, “5 times”, “dumplings”, and “4 times” in the first information.

In addition, the information analysis t 230 analyzes captions, images, and voices included in a video displayed in the vehicle to generate a list of words. The information analysis unit 230 generates information on words whose frequency of use in the form of captions, images, and voices exceeds a preset second threshold value among the words in the list of words.

The video displayed in the vehicle may be a video received from a server. For example, the server may be an OTT server.

In addition, the video displayed in the vehicle may be a video received from a device connected to the vehicle. The device connected to the vehicle may be a USB device.

The information on words whose frequency of use in the form of captions, images, and voices exceeds a preset second threshold value among the words in the list of words may be included in second information generated by the information analysis unit 230.

The second information may include information in which the words in the list of words are sorted in order of frequency of use during a preset second critical time.

The first threshold value and the second threshold value may be set to the same value or may be set to different values.

The first critical time and the second critical time may be set to the same time or may be set to different times.

In addition, the information analysis unit 230 generates interest information on the basis of the first and second information.

The interest information may be generated by combining the first information and the second information.

The interest information may be a common word or related words that can match each other among the words in the first information and the second information.

In addition, the interest information may be generated on the basis of only one of the first information or the second information.

For example, the interest information may be (e.g., may include) information sorted by adding the frequency with which the words included in the first information are used and the frequency with which the words included in the second information are used.

The matching unit 250 generates content to be provided on the basis of the interest information generated by the information analysis unit 230 and the POI information received from the server through the communication unit 210. The matching unit 250 transmits the same to the content provider 270.

The content to be provided may be generated on the basis of at least one of weather information, date information, or time information.

The POI information may be (e.g., may include) information on a store stored in the database in the server.

The information on the store may include at least one of identification information (identifier) of the store, information on items currently on discount, discount rates of the items currently on discount, or a combination thereof.

The content provider 270 provides the content generated by the matching unit 250 to the passengers.

The generated content be provided as audio or video information to the passengers through the vehicle or the terminal. For example, the content provider 270 may include a speaker and a display screen, and the generated content may be provided as audio or video information.

The generated content may be advertising content and may be transmitted through push notification.

The content provider 270 may provide the content to be provided to the passengers on the basis of the vehicle location information received from the communication unit 210.

For example, the content provider 270 may provide the generated content when the vehicle approaches within a preset threshold distance from a store related to the POI information.

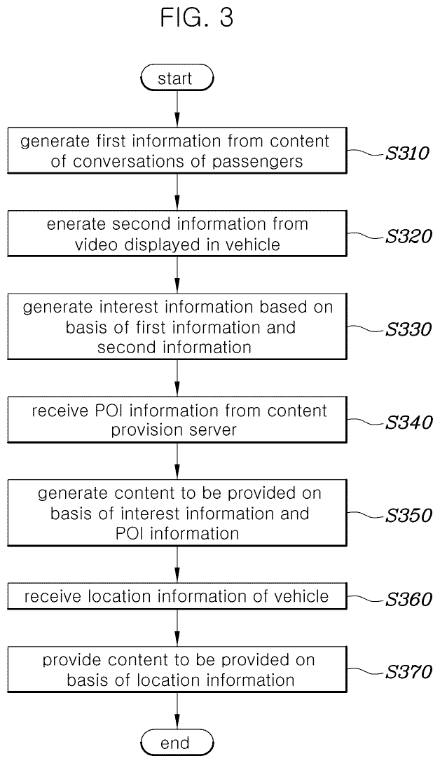

FIG. 3 is a flowchart showing a content provision method, according to an embodiment of the present disclosure.

The content provision method according to an embodiment may be performed by the content provision apparatus according to the embodiment shown in FIG. 2.

In an operation S310, the content provision apparatus generates first information from content of conversations of passengers of a vehicle.

The content of conversations of the passengers may be received by a microphone or a terminal installed in the vehicle.

The first information may be (e.g., may include) information on words whose frequency of use exceeds a preset first threshold among words included in the conversations, obtained by analyzing the conversations of the vehicle passengers through voice recognition.

The first information may be (e.g., may include) information in which words included in the conversation are sorted in order of frequency of use during a preset first critical time.

In an operation S320, the content provision apparatus generates second information from a video displayed in the vehicle.

The second information may be (e.g., may include) information on words whose frequency of use in the form of captions, images, and voice exceeds a preset second threshold among words in a list of words when the captions, images, and voice included in a video received by the vehicle from a server or an external device are analyzed to generate the list of words.

The video displayed in the vehicle may be a video received from a server. For example, the server may be an OTT server.

Additionally, or alternatively, the video displayed in the vehicle may be a video received from a device connected to the vehicle. The device connected to the vehicle may be a USB device.

The second information may be (e.g., may include) information in which the words in the list of words are sorted in order of frequency of use during a preset second critical time.

The first threshold value and the second threshold value may be set to the same value or may be set to different values.

The first critical time and the second critical time may be set to the same time or may be set to different times.

In an operation S330, the content provision apparatus generates interest information based on the first and second information.

The interest information may be generated by combining the first information and the second information.

The interest information may be a common word or related words that can match each other among words in the first information and the second information.

For example, the interest information may be (e.g., may include) information sorted by adding the frequency with which words included in the first information are used and words included in the second the frequency with which information are used.

Further, the interest information may be generated on the basis of only one of the first information and the second information.

In an operation S340, the content provision apparatus receives POI information from a server and

In an operation S350, the content provisioning apparatus generates content to be provided on the basis of the interest information and the POI information.

The server may be a content providing server, and the POI information may be (e.g., may include) information on a store stored in a database in the content providing server.

Here, the information on the store may include at least one of identification information of the store, information on items currently on discount, discount rates of the items currently on discount, or a combination thereof.

In an operation S370, the content provision apparatus receives location information of the vehicle (S360) and provides the generated content to the passengers on the basis of the location information.

The content to be provided to the passengers may be generated on the basis of one or more of weather information, date information, and time information.

The generated content may be provided to the passengers as audio or video information to passengers through the vehicle or terminal. For example, the generated content may be provided to the passengers as audio or video information through a speaker or a display screen provided by the vehicle or terminal.

The generated content may be advertising content and may be transmitted through push notification.

The generated content may be provided to the passengers when the vehicle approaches within a preset threshold distance from a store related to the POI information.

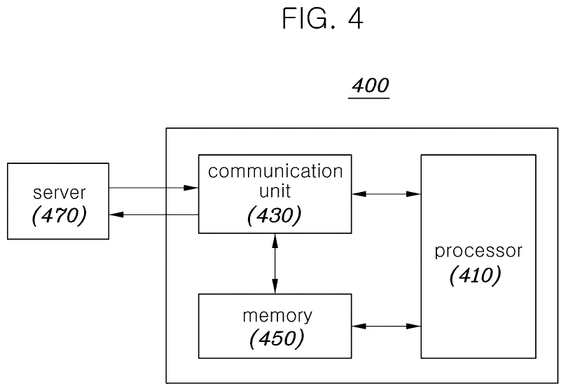

FIG. 4 is a block diagram showing an example of a computer system. according to an embodiment of the present disclosure.

Referring to FIG. 4, embodiments of the present disclosure may be implemented in a computer system such as a computer-readable recording medium. As shown in FIG. 4, the computer system 400 includes a processor 410, a communication unit 430, and a memory 450. The communication unit 430 communicates with an external server 470.

The processor 410 implements the in-vehicle content provision method and/or apparatus according to embodiments of the present disclosure. For example, the processor 410 implements all operations of the content provision apparatus described in the embodiments described herein, the processor 410 performs all operations of the content provision method according to FIG. 3, for example.

For example, the processor 410 generates first information from content of conversations of passengers of a vehicle. The processor 410 also generates second information from a video displayed in the vehicle. The processor 410 further generates interest information on the basis of the first information and the second information. The processor 410 additionally generates content to be provided on the basis of the interest information and POI information. The processor 410 also provides the generated content to the passengers of the vehicle.

The first information may be (e.g., may include) information on words whose frequency of use exceeds a preset first threshold among words included in the conversations, obtained by analyzing the conversations of the passengers through voice recognition.

The first information may be (e.g., may include) information in which words included in the conversation are sorted in order of frequency of use during a preset first critical time.

The second information may be (e.g., may include) information on words whose frequency of use in the form of captions, images, and voice exceeds a preset second threshold among words in a list of words when the captions, images, and voice included in a video received by the vehicle from the server 470 or an external device are analyzed to generate the list of words.

The second information may be (e.g., may include) information in which words in the list of words are sorted in order of frequency of use during a preset second critical time.

The interest information may be a common word or related words that can match each other among words in the first information and the second information.

In addition, the interest information may be generated on the basis of only one of the first information or the second information.

The POI information may be (e.g., may include) information on a store stored in a database in the server.

The information on the store may include at least one of identification information of the store, information on items current on discount, discount rates of the items currently on discount, or a combination thereof.

The processor 410 may provide the content to be provided on the basis of location information of the vehicle.

The content to be provided to the passengers may be generated on the basis of one or more of weather information, date information, and time information.

The location information of the vehicle may be received from a global positioning system (GPS) server.

The content to be provided to the passengers may be provided when the vehicle approaches within a preset threshold distance from the store.

The communication unit 430 is connected to the processor 410. The communication unit 430 may directly obtain information from the server 410. For example, the communication unit 430 receives POI information and vehicle location information from the server 470. The communication unit 430 may also transmit information to the server 470.

The memory 450 may be various types of volatile or non-volatile storage media. The memory 450 may store at least one of the first information generated from the content of conversations of vehicle passengers, the second information generated from a video displayed in the vehicle, the interest information generated on the basis of the first information and the second information, the POI information received from the server, the content generated on the basis of the interest information and the POI information, or a combination thereof.

According to various embodiments of the present disclosure, customized advertising content based on the content of conversations of passengers or video information displayed in a vehicle may be provided.

In addition, useful information such as information on restaurants or other stores and discount t information related thereto may be provided to vehicle passengers on the basis of information generated by matching POI information with words extracted from the content of conversations of the passengers and video information displayed in the vehicle.

In addition, by analyzing conversations of passengers and videos that the passengers watch, appropriate advertisements that suit the tastes of the passengers may be displayed.

In addition, even if passengers are not watching a video, an advertisement corresponding to conversations may be displayed on the basis of only the conversations.

In addition, even if passengers do not speak, an appropriate advertisement is displayed on the basis of only video viewing information.

In addition, an advertisement in the form of suggestions is provided by combining the content of conversations of passengers or video information being displayed with weather information or time information.

In addition, advertisements may be provided by calculating purchase cycles of items for user's interests.

In addition, embodiments of the present disclosure may be applied to online shopping as well as POI with respect to analyzed specific word related advertisements.

The effects that can be obtained from the present disclosure are not limited to the effects mentioned above. Other effects not mentioned herein should be clearly understood by those having ordinary skill in the art from the description above.

Embodiments of the present disclosure can be implemented as computer-readable code on a program-recorded medium. Computer-readable media includes all types of recording devices that store data that can be read by a computer system. Examples of computer-readable media include a hard disk drive (HDD), a solid state drive (SSD), a silicon disk drive (SDD), a ROM, a RAM, a CD-ROM, a magnetic tape, a floppy disk, an optical data storage device, etc.

The above detailed description should not be construed as restrictive in all respects and should be considered illustrative. The scope of the present disclosure should be determined by reasonable interpretation of the appended claims, and all changes within the equivalent scope of the present disclosure are included in the scope of the present disclosure.

What is claimed is:

1. A method of providing content, the method comprising:
generating first information from content of conversations of passengers of a vehicle;
generating second information from a video displayed in the vehicle;
generating interest information on the basis of the first information and the second information;
receiving point-of-interest (POI) information from a server;
generating, on the basis of the interest information and the POI information, content to be provided to the passengers of the vehicle; and
providing the generated content to the passengers of the vehicle.

2. The method of claim 1, wherein the first information includes information on words whose frequency of use exceeds a preset first among threshold words included in the conversations, obtained by analyzing the conversations of the passengers of the vehicle through voice recognition.

3. The method of claim 2, wherein the first information includes information in which words included in the conversations are sorted in order of frequency of use during a preset first critical time.

4. The method of claim 1, wherein the second information includes information on words whose frequency of use in captions, images, and voice exceeds a preset second threshold among words in a list of words, wherein captions, images, and voice included in a video received by the vehicle from a server or an external device are analyzed to generate the list of words.

5. The method of claim 4, wherein the second information includes information in which the words in the list of words are sorted in order of frequency of use during a preset second critical time.

6. The method of claim 1, wherein the POI information includes information on a store stored in a database in the server.

7. The method of claim 6, wherein the information on the store includes at least one of identification information of the store, information on items currently on discount, discount rates of the items currently on discount, or a combination thereof.

8. The method of claim 6, further comprising receiving location information of the vehicle, wherein providing the generated content to the passengers of the vehicle includes providing the generated content on the basis of the location information of the vehicle.

9. The method of claim 8, wherein the location information of the vehicle is received from a global positioning system (GPS) server.

10. The method of claim 1, wherein the interest information includes a common word or related words matching each other among words in the first information and the second information.

11. An apparatus for providing content, the apparatus comprising:
a communication unit configured to receive point-of-interest (POI) information from a server; and
a processor configured to
generate first information from content of conversations of passengers of a vehicle,
generate second information from a video displayed in the vehicle,
generate interest information on the basis of the first information and the second information,
generate, on the basis of the interest information and the POI information, content to be provided to the passengers of the vehicle, and
provide the generated content to the passengers of the vehicle.

12. The apparatus of claim 11, wherein the first information includes information on words whose frequency of use exceeds a preset first threshold among words included in the conversations, obtained by analyzing the conversations of the passengers of the vehicle through voice recognition.

13. The apparatus of claim 12, wherein the first information includes information in which words included in the conversations are sorted in order of frequency of use during a preset first critical time.

14. The apparatus of claim 11, wherein the second information includes information on words whose frequency of use in captions, images, and voice exceeds a preset second threshold among words in a list of words, wherein captions, images, and voice included in a video received by the vehicle from a server or an external device are analyzed to generate the list of words.

15. The apparatus of claim 14, wherein the second information includes information in which the words in the list of words are sorted in order of frequency of use during a preset second critical time.

16. The apparatus of claim 11, wherein the POI information includes information on a store stored in a database in the server.

17. The apparatus of claim 16, wherein the information on the store includes at least one of identification information of the store, information on items currently on discount, discount rates of the items currently on discount, or a combination thereof.

18. The apparatus of claim 16, wherein the communication unit is further configured to receive location information of the vehicle, and wherein the processor is configured to provide the generated content on the basis of the location information of the vehicle.

19. The apparatus of claim 18, wherein the location information of the vehicle is received from a global positioning system (GPS) server.

20. The apparatus of claim 11, wherein the interest information includes a common word or related words matching each other among words in the first information and the second information.
